(19) United States
(12) Patent Application Publication
(10) Pub. No.: US 2025/0350357 A1
(43) Pub. Date: Nov. 13, 2025

(54) OPTICAL WIRELESS DEVICES AND METHOD FOR DESIGNING AN OPTICAL ARRANGEMENT

(71) Applicant: Fraunhofer-Gesellschaft zur Förderung der angewandten Forschung e.V., München (DE)

(72) Inventors: René KIRRBACH, Dresden (DE); Tobias SCHNEIDER, Dresden (DE)

(21) Appl. No.: 19/271,010

(22) Filed: Jul. 16, 2025

Related U.S. Application Data
(63) Continuation of application No. PCT/EP2024/050905, filed on Jan. 16, 2024.

(30) Foreign Application Priority Data
Jan. 20, 2023 (DE) 102023200446.1

(51) Int. Cl. H04B 10/11; H04B 10/67

(52) U.S. Cl. CPC H04B 10/11; H04B 10/67

(57) ABSTRACT

An optical wireless device with a receiving device is configured to receive an optical wireless signal. The receiving device includes an optical detector for detecting the optical wireless signal and a plurality of optical systems with at least a first optical system with a first aperture size and a second optical system with a second, smaller aperture size. The optical systems are arranged side by side and essentially in the same advantageous direction. Each of the plurality of optical systems is configured to simultaneously direct a light incident on the optical system to the optical detector. The optical detector has an optical axis and the first optical system is arranged at a first distance from the optical axis and the second optical system is arranged at a greater second distance from the optical axis.

### CROSS-REFERENCE TO RELATED APPLICATIONS

This application is a continuation of copending International Application No. PCT/EP2024/050905, filed Jan. 16, 2024, which is incorporated herein by reference in its entirety, and additionally claims priority from German Application No. 102023200446.1, filed Jan. 20, 2023, which is also incorporated herein by reference in its entirety.

The present invention relates to optical wireless devices for receiving optical wireless signals, to a communication system with such optical wireless devices and to a method for designing an optical arrangement for a receiving device of an optical wireless device. The present invention relates in particular to a highly efficient complex lens setup for high dynamic ranges for optical wireless or optical cordless transmitter/receiver systems.

### BACKGROUND OF THE INVENTION

Receivers of optical wireless or optical cordless transceivers can be exposed to widely varying reception levels. On the one hand, a high optical transmitting power is needed for a long range. However, increasing the transmitting power also increases the minimum distance between the transceivers or the minimum distance between the transmitter and receiver. Below the minimum distance, the channel loss is so low that the receiver becomes saturated and transmitting is no longer possible. The distance range between transmitter and receiver in which operation within the specification is possible is defined as the dynamic range of the transceiver. This distance range is limited downwards by the minimum distance and upwards by the maximum distance. A transceiver is particularly versatile if it has a large dynamic range.

There are various approaches for increasing the dynamic range of a link:
Regulation of the transmitting power: At short distances, the transmitting power is reduced adaptively [1, 4] in order to avoid receiver saturation. However, this approach needs a driver circuit with adaptive control. The system also needs to know when to reduce or increase the transmitting power. This information is received from a receiver of the communication subscriber. The approach is generally limited to a regulation range of 3 dB to 20 dB.
Regulation of the electrical receiver: The electrical receiver can be regulated, for example by regulating the gain of the transimpedance amplifier or by using an additional regulation at the input of the transimpedance amplifier [1, 6]. This approach is not always suitable, for example if the saturation effect already occurs at the photodetector. Such saturation effects are common in avalanche photodiodes (APDs), single-photon avalanche photodiodes (SPADs) and also in silicon photomultipliers (SiPM). Although the internal gain of these detectors can be regulated via the bias voltage, this is only possible over a certain range until the internal gain is 1 (lowest value) or until the effective photodiode capacitance no longer fulfils the specification.
Use of one or more additional elements to attenuate the optical signal, such as a mechanical shutter [2], a variable aperture [5], a variable lens (electro-wetted lens, polymer lens, etc.), a polarisation-based shutter (e.g. liquid crystal shutter/attenuator [2]). What all these approaches have in common is that an additional element is used in the system to influence the channel loss in particular, usually by increasing the channel loss in the geometric near field. The additional component and the additional control needed increase system complexity and costs.
The optical system may provide that the transmitter and receiver are not on the same optical axis. The field of view is selected in such a way that the receiver can barely see the transmitter at close range, if at all. This approach is very simple, but usually limited in the dynamic range of 3 dB to 10 dB. This is particularly important for small fields of view. This approach is particularly susceptible to an offset perpendicular to the optical axis. If, for example, it is defined that the receiver receives a signal strength from the transmitter at a short distance that is just within the evaluation range, but the receiver is now additionally offset by a further 10 mm due to the tolerance, for example, the receiver may no longer be able to detect anything.
   This concept may be extended so that the transmitter also emits at larger angles, see [3], and the receiver is also capable of detecting signals arriving at these larger angles. The disadvantage of this approach, however, is that power is not optimally utilised at the transmitter because a receiver at a greater distance cannot detect this laterally emitted power. In addition, the receiver lens cannot be optimally designed for the actual acceptance angle, as it has to collect radiation in the geometric near field even at larger radiation angles. The field of view is therefore no longer well defined, so that channel crosstalk with neighbouring channels may occur. The approach is also sensitive to positioning tolerances between transmitter and receiver.
The optical concept may provide several receivers. These may have a different saturation limit, for example by using different detectors, see [2]. One detector is used at close range and one at long range. This approach involves more hardware, as a second detector and additional amplifier electronics are also needed. In addition, both receiver channels is to be combined or a decision is to be made as to which data stream is analysed.

There is therefore a need for solutions for the efficient operation of optical wireless devices and for designing the needed components that enable a high dynamic range between transmitter and receiver of an optical wireless communication link.

### SUMMARY

An embodiment may have an optical wireless device with a receiving device which is configured to receive an optical wireless signal; wherein the receiving device includes an optical detector for detecting the optical wireless signal and a plurality of optical systems with at least a first optical system with a first aperture size and a second optical system with a second smaller aperture size arranged side by side with substantially the same advantageous direction; wherein each of the plurality of optical systems is configured to simultaneously direct a light incident on the optical system to the optical detector; wherein the optical detector includes an optical axis and the first optical system is arranged at a first distance from the optical axis and the second optical system is arranged at a greater second distance from the optical axis.

Another embodiment may have an optical wireless device with a receiving device which includes an optical detector and which is configured to receive an optical wireless signal from an optical wireless transmitter; wherein the receiving device is configured to receive the optical wireless signal both in a geometric near field and in a geometric far field of the optical wireless transmitter and to detect it with the receiving device without saturation, in that the optical wireless device is configured to receive the optical signal of the transmitter in the geometric near field of the transmitter with the optical detector merely by a subset of the plurality of optical systems, and in the geometric far field, other or a higher number of the plurality of optical systems receive the signal.

According to another embodiment, an optical wireless communication system may have: a first inventive optical wireless device; and a second optical wireless device which is configured to transmit the optical wireless signal; wherein at different distances between the first optical wireless device and the second optical wireless device, a different number of optical systems of the receiving device of the first optical wireless device is illuminated with the transmitted optical wireless signal and contribute to a total optical power directed to the detector. Final version of the Continuation Application. DOCX

A key idea of the present invention is to have recognised that a saturation effect at an optical detector of a receiver can be reduced or avoided by equipping the receiver with a plurality of optical systems which direct the received light to the optical detector. In a geometric near field of the transmitter, the optical detector only receives the optical signal of the transmitter from a subset of the plurality of optical systems, whereas from other optical systems or a higher number of the plurality of optical systems in the geometric far field. This is achieved, for example, by different optical systems of the plurality of optical systems having different distances from one another to an optical axis of the detector and the optical systems being arranged with essentially the same advantageous direction. Based on the side-by-side arrangement, it is possible that, when the distance to the transmitter is reduced, optical systems become partially unilluminated or less illuminated and therefore their contribution to the total power at the optical detector decreases, thus avoiding a saturation effect. This achieves a small minimum distance or even avoids the minimum distance. At the same time, a high degree of the transmitting power of the transmitter can be utilised in the geometric far field, so that a high dynamic range is achieved with high efficiency.

In an embodiment, an optical wireless device is provided which comprises a receiving device for receiving an optical wireless signal. The receiving device includes an optical detector for detecting or receiving the optical wireless signal and a plurality of optical systems with at least a first optical system with a first aperture size and a second optical system with a second, smaller aperture size. The optical systems are arranged side by side and essentially in the same advantageous direction. Each of the plurality of optical systems is configured to simultaneously direct a light incident on the optical system to the optical detector. The optical detector has an optical axis and the first optical system is arranged at a first distance from the optical axis, wherein the second optical system is arranged at a greater second distance from the optical axis.

According to an embodiment, an optical wireless device is provided which comprises a receiving device which comprises an optical detector and which is configured to receive an optical wireless signal from an optical wireless transmitter. The receiving device is configured to receive the optical wireless signal both in a geometric near field and in a geometric far field of the optical wireless transmitter and to detect it without saturation using the optical detector.

Further embodiments relate to an optical wireless communication system with an optical wireless device described herein.

According to an embodiment, a method for designing an optical arrangement for a receiving device of a optical wireless device includes designing and positioning a plurality of optical systems with respect to a transmitting device configured to provide an optical wireless signal, so that the plurality of optical systems deflect a received optical wireless signal simultaneously, so that at different distances between the receiving device and the transmitting device a different number of the plurality of optical systems contribute to a total optical power directed to the optical detector of the receiving device. The method further includes producing the plurality of optical systems in an arrangement according to the designing and positioning.

### BRIEF DESCRIPTION OF THE DRAWINGS

Embodiments of the present invention will be detailed subsequently referring to the appended drawings, in which:

FIG. 1 is a schematic side sectional view of an optical wireless device according to an embodiment;

FIG. 2 is a schematic side sectional view of an optical wireless communication system according to an embodiment;

FIG. 3a is a schematic side sectional view of an arrangement of a transmitting device and a receiving device in the geometric near field in accordance with embodiments described herein;

FIG. 3b is a schematic side sectional view of the same components as in FIG. 3a, but in the geometric far field;

FIG. 4a is a schematic top view of an optical wireless device according to an embodiment;

FIG. 4b is a representation of the device in FIG. 4a, extended by a transmitting device of an opposite device;

FIG. 4c is a schematic, partially perspective view of two devices according to FIG. 4a and FIG. 4b, which are reciprocal copies of each other, according to an embodiment;

FIG. 4d is a schematic representation of an optical wireless device according to an embodiment with a receiving optical systems with an approximately rectangular cross-section according to an embodiment;

FIG. 5 is a schematic characteristic curve of a received power at an optical detector for the discussion of embodiments described herein;

FIG. 6 is a schematic front view of an optical wireless device according to an embodiment, which comprises a plurality of secondary optical systems;

FIG. 7 is a schematic diagram of an exemplary total intensity, such as can be obtained with an optical arrangement of the optical wireless device of FIG. 6, according to an embodiment; and

FIG. 8 is a schematic flow chart of a method according to an embodiment.

### DETAILED DESCRIPTION OF THE INVENTION

Before the following embodiments of the present invention are explained in more detail with reference to the drawings, it is pointed out that identical, functionally identical or similarly acting elements, objects and/or structures are provided with the same reference signs in the different figures, so that the description of these elements shown in different embodiments is interchangeable or can be applied to one another.

The following embodiments are described in connection with a large number of details. However, embodiments may also be implemented without these detailed features. Furthermore, for the sake of clarity, embodiments are described using block diagrams as a substitute for a detailed illustration. Furthermore, details and/or features of individual embodiments can be combined with one another, as long as it is not explicitly described to the contrary.

The following embodiments refer to optical wireless signal transmission or data transmission. This is also referred to as LiFi (Light Fidelity; light transmission) in the context of the embodiments described herein. The term “LiFi” refers to terms such as IrDA (Infrared Data Association) or OWC (Optical Wireless Communication). This means that the terms “optical wireless data transmission”, “optical cordless data transmission” and “LiFi” are used synonymously. Optical wireless data transmission is understood to mean transmitting an electromagnetic signal through a free transmission medium, such as air or another gas or fluid. For example, wavelengths in an ultraviolet (UV) range of at least 100 nm and the infrared range, for example at most 1550 nm, can be used for this purpose, although other wavelengths are also possible that differ from the wavelengths used for radio standards. Optical wireless data transmission also has to be distinguished from fibre-optic data transmission, which is implemented using optical waveguides or optical waveguide cables, for example.

The embodiments described herein relate to a near field and/or a far field, which are referred to synonymously as a geometric near field or geometric far field.

A geometric near field is understood to be an area starting from the transmitter in which the position and size of individual elements of the receiver and transmitter play a major role in the reception level of optical wireless signals, in addition to the emission angle of the transmitter. In addition to the positions and dimensions, angular ranges of the optical systems may also play a role. For example, a transmitter can emit the optical wireless signal in an angle range from −1° to +1°. If the acceptance angle of the receiver is smaller than the transmission angle, e.g. −0.5° to +0.5°, the angular effect also results in a loss which, however, can be used as channel attenuation according to the invention and which is not initially influenced by the spatial dimensions. In addition to the emission and reception angles, the lateral offset from transmitter to receiver and the spatial extension of the transmitter and receiver aperture also have an influence in the geometric near field.

The geometric far field, on the other hand, is understood to be a different area in which, starting from the transmitter, the radiation angle of the transmitter plays a major role and the dimensions and position of the receiver components and the transmitter components, in particular the optical systems, play a smaller role. A geometric far field, on the other hand, can be understood as an arrangement in which the emission characteristics of the transmitter and the reception characteristics of the receiver can essentially be described by their emission and reception angles.

The transition between geometric near field and geometric far field is fluid.

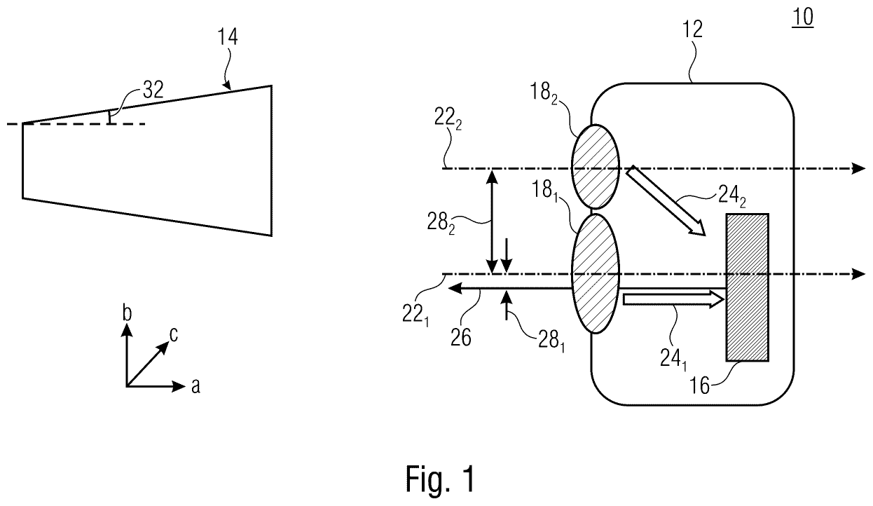

FIG. 1 shows a schematic side sectional view of an optical wireless device 10. The optical wireless device 10 includes a receiving device 12, which is configured to receive an optical wireless signal 14. The receiving device includes an optical detector 16, which may, for example, comprise a photodiode, such as a PIN photodiode, an avalanche photodiode (APD), a single-photon avalanche photodiode (SPAD) and/or a silicon photomultiplier (SiPM).

Furthermore, the receiving device 12 comprises a plurality of optical systems 18₁, 18₂. The number of optical systems in the plurality of optical systems is two or more, such as two, three, four, five or more.

At least some of the different optical systems 18₁ and 18₂ have a different aperture size from one another, which is represented, for example, by a different size of the optical systems 18₁ and 18₂. In the illustration of FIG. 1, for example, the optical system 18₁ has a first aperture size larger than the optical system 18₂ with a second, smaller aperture size.

For further illustration, reference is made to a Cartesian coordinate system with the axes a, b and c, for example, wherein the axes are merely arranged orthogonally to each other in space as an example. The optical systems 18₁ and 18₂ are arranged side by side and have an essentially identical or matching advantageous direction 22₁ or 22₂. These run, for example, along a negative a-direction, so that an arrangement of the optical systems 18₁ and 18₂ side by side can be understood as an offset along a b-direction and/or c-direction, which does not exclude an additional offset along the a-direction. It should be noted that each of the optical systems 18₁ and 18₂ may be configured as a single optical element but also as a combination of optical elements, for example as a single or multiple complex lens modules and/or as a combination of lenses and reflectors.

In the schematic representation of FIG. 1, the optical systems 18₁ and 18₂ are arranged offset to each other along the b-direction and spaced apart from each other. However, even with an additional offset along the c-direction, for example, there could be an overlap in a projection plane arranged parallel to the a-direction and b-direction between the optical systems 18₁ and 18₂.

Each of the optical systems 18₁ and 18₂ is configured to direct a light incident on the optical system to the optical detector 16, as shown by the arrows 24₁ and 24₂. This takes place simultaneously, i.e. portions of optical power incident on the optical detector are simultaneously detected by several optical systems and superimposed at the location of the optical detector. The superimposition is preferably so low in interference, for example due to different optical wireless signal paths, that correctable interference-free or error-free reception is possible.

This means that it is possible that when the optical systems 18₁ and 18₂ are simultaneously illuminated with the optical wireless signal 14, both optical systems 18₁ and 18₂ simultaneously direct a corresponding portion onto the optical detector 16. When illuminating only a subset, such as only one optical system 18₁ or 18₂, it is also possible and provided for in the context of embodiments described herein, that only a subset of the optical systems 18₁ or 18₂ directs a portion onto the optical detector 16, but a portion of another optical system is omitted or becomes negligible for a total optical power at the optical detector 16.

The optical detector 16 has an optical axis 26 which can, for example, run along a primary advantageous direction of the optical detector 16 in space. For example, the optical axis 26 additionally runs through a centre point of a sensitivity curve, such as a geometric centre point, of the optical detector 16 and/or is positioned normally on a detector surface of the optical detector 16.

The optical system 18₁ has a distance 28₁ to the optical axis 26, while the optical system 18₂ has a greater distance 28₂ to the optical axis 26. Matching positions or features of the optical systems 18₁ and 18₂ may be considered as the reference point or reference range for determining the distance 28₁ and 28₂, for example an optical centre point or a position of the advantageous directions 22₁ or 22₂. Alternatively, an outer edge or lateral boundary facing the optical axis 26 or other features may be considered as a reference.

Such an arrangement of the optical systems 18₁ and 18₂ with respect to each other and/or with respect to the optical detector 16 makes it possible, with respect to an emission angle 32 of the optical wireless signal 14, to assume different situations at different distances between the device 10, in particular the receiving device 12 and a transmitter of the optical wireless signal 14, in which, for example, several or even all optical systems 18₁ and 18₂ of the plurality of optical systems are illuminated at a comparatively large distance, or receive the optical wireless signal 14. If the distance is reduced, this can result in at least one of the optical systems, such as 18₁, being illuminated less or no further by the optical wireless signal 14 and correspondingly less power reaching the optical detector 16 through this optical system, while possibly, but not necessarily, an optical power can increase through the other optical system that continues to be illuminated, i.e. the optical system 18₂. These two opposing effects may result in that the optical detector 16 is not saturated, even if the distance to the transmitter is greatly reduced.

In an embodiment, the optical wireless device 10 can be positioned or arranged with respect to a transmitter in an optical wireless communication network or communication system such that the transmitter of the optical wireless signal 14 is arranged opposite an optical system 18₂, also referred to as a secondary optical system, with a smaller aperture, so that an optical system with a larger aperture, referred to as the primary optical system, the optical system 18₁, is positioned out of an illumination cone of the optical wireless signal 14 when the distance to the transmitter is reduced.

The distance 28₁ is less than the distance 28₂; preferably the distance 28₁ is at least within manufacturing tolerances 0 or essentially 0, which means that the optical system 18₁ can be arranged centrally above the optical detector 16. An arrangement above the optical detector 16 is not necessarily to be understood as meaning that a height direction has to be considered for this purpose; such an indication refers to a direction along the optical axis 26. In general, indications such as left, right, top, bottom, front or rear in connection with the embodiment described herein are only used for better illustration and have no limiting effect unless explicitly stated. It is understood that such relative indications can be changed at will by shifting and/or rotating in space.

An arrangement of the optical system 18₁ above, centrally or centred above the optical detector 16 means at the same time that the optical system 18₂ is arranged at a distance from the optical axis 26 of the optical detector 16.

While the optical system 18₁ may be configured to direct incident light along the advantageous direction 22₁ of the optical system 18₁ towards the optical detector 16, the optical system 18₂ may be configured differently from this in order to direct incident light along a direction different from the advantageous direction 22₂ towards the optical detector 16. This may be obtained by different optical effects regarding refraction and/or reflection or the like, that is, the optical system 18₂ can change a direction of the light travelling through the optical system 18₂. An orientation of the advantageous directions 22₁ and 22₂ may be along any positive or negative a-direction in space. The optical system 18₂ may, for example, be configured for refraction and at least a first total internal reflection, but possibly also a second or further total internal reflection, in order to direct the incident light along the direction different from the advantageous direction 22₂ towards the optical detector 16.

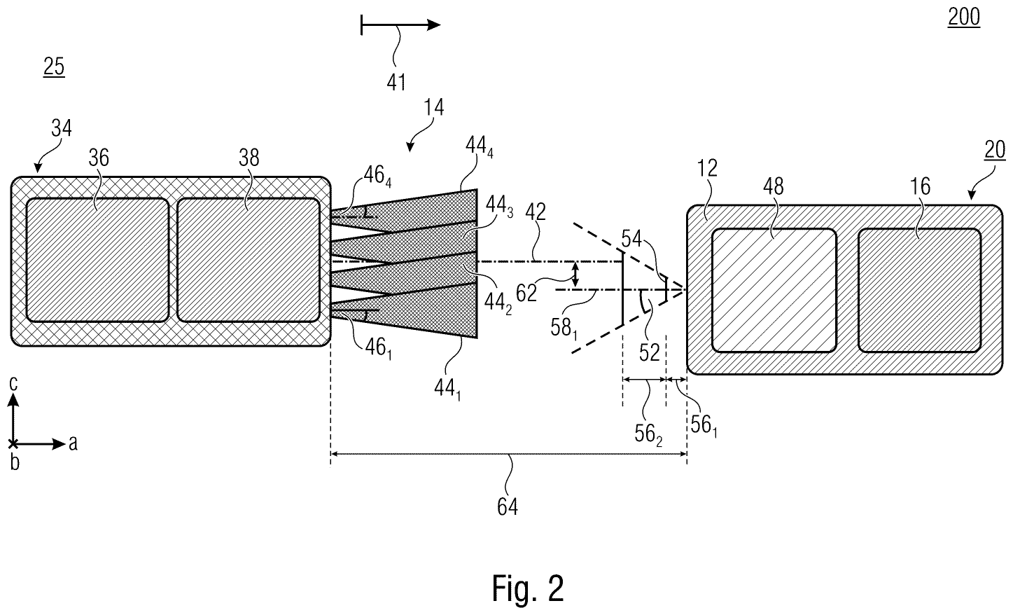

FIG. 2 shows a schematic representation of an optical wireless communication system 200 according to an embodiment, including an optical wireless device 20 according to an embodiment and a further optical wireless device 25, which may be configured to transmit the optical wireless signal 14. The optical wireless device 25 may include a transmitting device 34 which may, for example, receive an optical emitter 36 and a downstream transmitting optical system 38. The transmitting device 34 may be configured to transmit the optical wireless signal 14 along a primary transmission axis 42, which is arranged parallel to a advantageous direction 41, but not necessarily parallel to the a-direction for example, in space and may be arranged, for example, in the area of a maximum optical power of the optical wireless signal 14.

An emission profile of the optical wireless signal 14 may be composed of one, two, three, four or more sub-profiles in any number. For example, the transmitting device 25 may comprise an emitter array, a device for magnifying the apparent source on the transmitter side, or a device for generating multiple apparent sources of the optical emitter 36. According to an embodiment of an optical wireless communication system, the transmitting device 34 is configured as a device for magnifying the apparent source or for generating multiple apparent sources starting from the optical emitter 36. It comprises the optical emitter 36 for generating an optical signal and a separation optical system configured to spatially divide the optical signal into a plurality of optical partial signals to divide an optical power of the optical signal into a plurality of optical partial signals with an associated spectral range, wherein the plurality of spectral ranges at least partially coincide. Such a separation optical system is described in [7], for example, so that in such a case the partial signals 44₁ to 44₄ can be obtained in a corresponding number by the separation optical system. The emission angles 46₁ to 46₄ of the partial signals 44₁ to 44₄ may be the same or different. Notwithstanding this, and regardless of an implementation in a number of partial signals in total, the optical wireless signal 14 may have an emission angle that may result in an increase in an area illuminated by the optical wireless signal with increasing distance from the transmitting device 34.

The optical wireless device 20 may be configured in accordance with the discussion of the optical wireless device 10 and comprises, for example, a receiver optical system 48 having at least two optical systems, such as the optical systems 18₁ and 18₂. The receiver optical system 48 may have an acceptance angle 52, which may, for example, cause a received field of view 54 to have a planar extension, for example in a b/c-plane, which increases with increasing distance 56₁, 56₂ from the receiver optical system 48. According to an embodiment, the optical systems 18₁ and 18₂ of the optical wireless device 10 differ with respect to a size of a receiving field of view associated with the respective optical systems 18₁, 18₂. The primary optical system 18₁ may be the optical system with the largest receiving field of view of the plurality of optical systems. Here, the receiving field of view 54 is to be understood such that a respective optical system 18₁, 18₂ has a receiving field of view associated with the optical system, and the receiving fields of view overlap in the plurality of optical systems.

Alternatively or additionally, with reference to FIG. 1, the optical system 18₁ may have a smallest angle of incidence on the optical detector 16 among the plurality of optical systems. According to an embodiment based on it, optical axes between the receiving fields of view of the respective optical systems 18₁, 18₂ may be parallel to each other in a region between the receiving fields of view and the optical systems, such that each optical system may have an individual optical axis 58 that may result in an overall optical axis 58 of the receiver optical systems 48. An optical axis 58₁ of the optical system 18₁ is shown as an example. With reference to FIG. 1, a respective optical axis between the optical systems and the optical detector 16 may be inclined relative to an optical axis of the primary optical system, for example because the received light is deflected more by the secondary optical system than by the primary optical system, which may make little or no change in direction.

According to an embodiment, in an optical wireless communication system, the optical axis 58₁ of the primary optical system 18₁ is offset from the primary transmission axis 42 by a distance or offset 62. This may make it possible that, if a distance 64 between transmitter and receiver is sufficiently reduced, the primary optical system 18₁ is not further illuminated by the optical wireless signal 14 and, in this respect and in particular with regard to a possibly largest aperture within the plurality of optical systems, avoids saturation of the optical detector 16 by directing no or only low optical power through the primary optical system 18₁ to the optical detector 16. According to an embodiment, the primary transmission axis 42 may substantially coincide with an optical axis of a secondary optical system of the plurality of optical systems, for example with the optical system having the smallest aperture.

In this way, it can be achieved that in an optical wireless communication system, at different distances between the optical wireless devices 20 and 25, a different number of optical systems of the receiving device 12 is illuminated with the transmitted optical wireless signal 14 and contribute to a total optical power directed to the detector 16.

According to an embodiment, the optical system 18₁ as a primary optical system of the plurality of optical systems in a geometric far field of the optical transmitter device 34 may provide a dominant portion to the total optical power at the optical detector 16 and a secondary optical system, such as the optical system 18₂ of FIG. 1, in a geometric near field of the transmitter device 34 may provide a dominant portion to the total optical power at the optical detector 16.

With reference to the primary transmission axis 42, the secondary optical system or all secondary optical systems may be arranged at a smaller distance from the primary transmission axis 42 than the primary optical system 18₁.

It is preferable if an acceptance angle 52 of the plurality of optical systems, i.e. the receiving device 12, is smaller than the resulting total emission angle of the transmitting device 12.

FIG. 2 first considers a possible unidirectional link from the optical wireless device 25 to the optical wireless device 20. A bidirectional link may be made possible by arranging a corresponding transmitting device on or in the device 20 and a suitable receiving device on or in the device 25. In other words, some of the previous considerations are initially limited to a unidirectional link, i.e. a data link consisting of a transmitter 25 and a receiver 20. All the concepts considered here may also be extended to bidirectional communication. Design examples for bidirectional transceivers are discussed below.

Although the discussion relates to optical wireless/optical cordless communication, the invention may also be extended to other applications in which an optical emitter and an optical receiver are used and a large dynamic range between the two is to be ensured. This also applies to optical distance meters, for example. This means that the optical wireless device 10 and/or 20 can possibly be used for communication, but the optical wireless signal 14 may also carry a different type of information, for example for distance measurement.

In other words, FIG. 2 shows a schematic representation of an optical wireless transmitter/receiver system consisting in a transmitter 25, an optical free-space channel and a receiver 20, or at least including these. The transmitter 25 consists in at least one optical emitter 36, such as a laser diode (LD) or a light-emitting diode (LED). In most cases, an additional transmitting optical system 38 may be used, for example a refracting lens or a total reflection lens. This transmitting optical system 38 may shape the emission profile. The emission angle 46 may characterise the angle at which the beams of the optical wireless signal 14 are emitted at maximum. The beams may be emitted along an advantageous direction 41. The advantageous direction 41 may correspond to the a axis; but this is not absolutely necessary. By way of example, the reference sign 42 denotes the optical axis of the transmitter 34 and the reference sign 58₁ denotes the optical axis of the primary receiving lens 18₁ of the optical wireless device 20. The receiver 12 consists of or includes the optical detector 16 and the receiving optical system 48. The receiving optical system 48 has the acceptance angle 52.

Embodiments enable the high dynamic range discussed by specifically increasing the channel loss at short communication distances 64, for example by moving at least one and in particular the primary optical system out of a light cone of the optical wireless signal 14. At long distances 64, on the other hand, no additional channel loss is introduced. Embodiments are based on the knowledge that one or more of the following effects can be specifically used to suitably control channel loss:
the offset 62 between the optical axis 42 of the transmitter 25 and the optical axis 58₁ of the primary receiving lens 18₁; and/or
the choice of a smaller acceptance angle 52 compared to a larger emission angle 46.

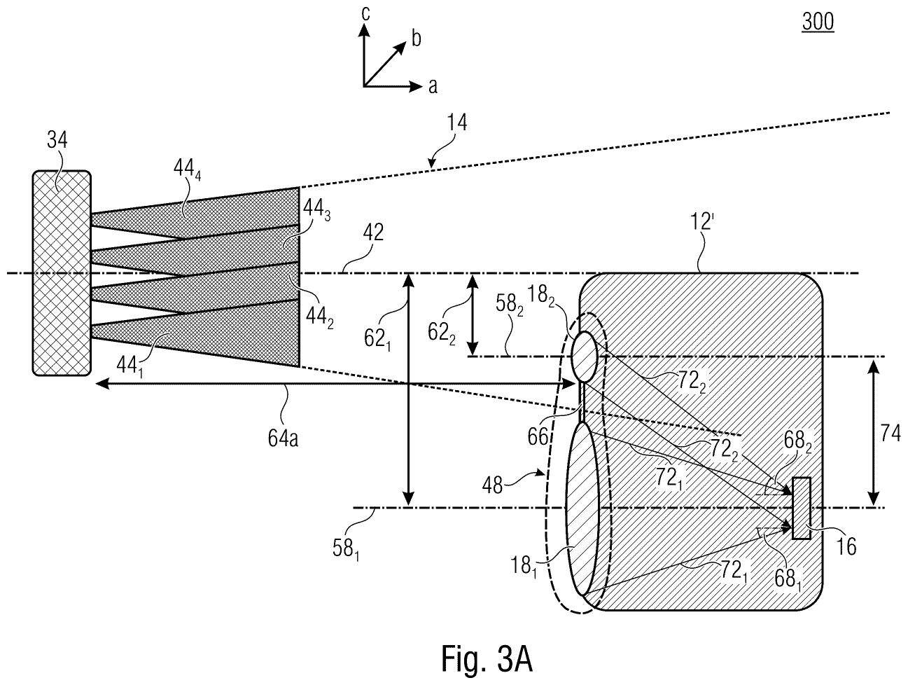

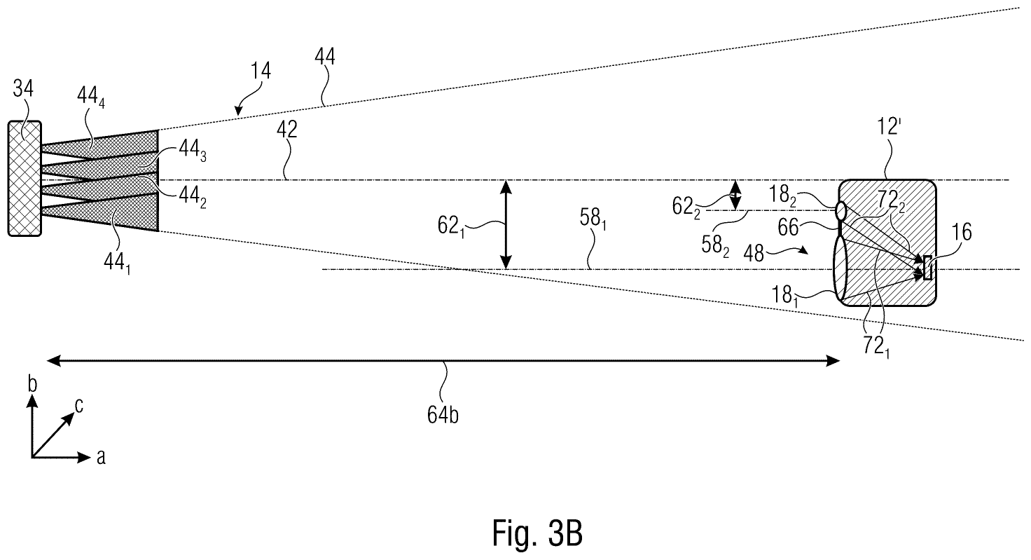

To further increase a practicability of the embodiments described herein, it is advantageous to provide that an alignment tolerance perpendicular to the optical axis 42 and/or 58₁ is tolerable and the communication system still functions. This can be achieved by:
the transmitting optical system 38 having a parallel output beam or an output beam with low divergence and/or an enlarged source or multiple apparent sources.
   This is indicated in FIG. 2 by a larger, apparent source, which may consist of several beams 44₁-44₄. This can be achieved as follows, among other things:
      a single optical emitter 36 in combination with a multi-path lens or separation optical system, which is advantageous in the context of the present embodiments; and/or
      several optical emitters, for example as an LED array and/or laser array, in combination with an optional lens array; and/or
      one or more optical emitters and a diffuser, such as a scattering diffuser, an engineered diffuser, a colour converter or the like.
   From the model point of view, the output profile of the optical wireless transmitter may then be seen as a plurality of sources, countable or uncountable, which may initially have the same or at least a similar emission profile.
As described in connection with FIG. 1, the receiving optical system 48 comprises a primary receiving lens 18₁ and at least one secondary lens 18₂. The secondary lens 18₂ may be located in the geometric near field within a field of view of the transmitter 25, as shown in FIG. 3a. The secondary lens 18₂ may also concentrate the incident light onto the photodetector 16. By dimensioning the secondary lens 18₂ in terms of area and offset 62₂ relative to the optical axis 42 of the transmitter 25, the receiving power in the geometric near range can be defined and the receiving power in the geometric far range can be defined via the primary receiving lens 18₁.

FIG. 3a shows a schematic side sectional view of an arrangement of the transmitting device 34 and a receiving device 12′ in accordance with embodiments described herein. The receiving device 12′ may essentially correspond to the embodiments for the receiving device 12, wherein, as an advantageous optional further feature, at least one optical system from the plurality of optical systems, here for example the optical systems 18₁ and 18₂, are fixed with respect to their relative position to one another via a connecting structure 66. The connecting structure 66 may have an optical property, but this is not necessary. One task of the connecting structure 66 is the relative positioning and/or fixation of optical systems 18₁ and 18₂ connected thereto. For example, the connecting structure 66 may be obtained and used during injection moulding or another moulding process, for example to introduce material into a mould and to locate any artefacts that may arise in an optically irrelevant area and at the same time to simplify production, as at least some of the plurality of optical systems can be produced in a single process step. It is conceivable that the connecting structure and one or more optical systems connected to it or fixed relative to each other form a common monolithic body.

In FIG. 3a, the receiver 12′ is located in the geometric near field of the transmitter 34, i.e. the distance 64a between the transmitter 34 and the receiver 12′ is small. FIG. 3b shows a schematic side section view of the same components, but in the geometric far field, i.e. the distance 64b between the transmitter 34 and the receiver 12′ is large.

One possible operation of the optical wireless communication system may be such that the transmitter 34 emits optical radiation 14 in a well-defined emission range/emission profile 44, which here may, for example, but not necessarily, have several virtual sources. The radiation is emitted along the advantageous direction parallel to the a direction along the optical axis 42. On the other hand, there is the receiver 12′, whose optical axis 58₁ of the primary receiving lens 18₁ may have the offset 62₁ to the axis 42. The offset 62₁ can be measured perpendicular to the optical axis 42 and may lie in a plane parallel to the b-direction and c-direction in the described embodiment. The optical axes 58₁ and 58₂ may be arranged at a distance 74 from each other.

The receiving optical system 48 can direct the incident radiation onto the detector 16. Here, the receiving optical system 48 comprises at least two optically active parts, the primary receiving lens 18₁, which provides a large optical concentration factor and is not irradiated or only irradiated to a lesser extent of at most 20%, at most 10% or at most 5% in the geometric near field than in the geometric far field and transfers power to the optical detector 16. It is conceivable, for example, that with the transmitting optical system and the primary optical system 18₁ aligned in parallel but opposite to each other, an emission angle of the transmitting device 34 is greater than an acceptance angle of the primary optical system 18₁, which may lead to the primary optical system 18₁ still being illuminated by the optical wireless signal 14 at certain distances due to the difference in angle, but this signal is not transferred to the optical detector. The secondary optical system 18₂, on the other hand, may act both in the geometric near field and in the geometric far field as it is irradiated to a similar extent in both cases, although its influence in the far field is rather negligible in some embodiments.

The primary optical system or primary receiving lens 18₁ may be any imaging or non-imaging optical system for concentration, such as a spherical lens, an aspherical lens, a free-form lens, a total reflective lens, a reflector, a so-called compound parabolic concentrator (a concentrator composed of at least two waveforms, CPC) or the like. The primary receiving lens or primary optical system 18₁ is, for example, arranged centrally above the photodetector 16 in order to enable the high concentration factor. The primary receiving lens 18₁ may simultaneously have the smallest angle of incidence 68 from the group of angles of incidence 68₁, 68₂ of the plurality of optical systems 18₁, 18₂ to the photodetector 16. The secondary lens 18₂ may therefore be offset relative to the photodetector 16 and direct the incident radiation onto the detector 16 at an angle 68₂, as shown by the beams 72₁ for the optical system 18₁ and the beams 72₂ for the optical system 18₂. According to embodiments, it may apply that 68₁≤68₂.

The beams 72₁ and 72₂ indicate schematically how the ray path may be realised in the design example. This course may also deviate from this, for example with the aid of additional optical components for beam steering or optical fibres. The optical axis 58₂ of the secondary optical system 18₂ may be unequal to the optical axis 58₁ of the primary receiving optical system 18₁. According to embodiments, the optical axis 18₂ may be arranged at least substantially or completely identical or coincident with the optical axis 42 of the transmitter 34 or may have an intentional or tolerance-related offset 62₂. This means that the offset 62₂ may also essentially correspond to the value of 0.

The offset 62₂ is usually smaller than the offset 62₁. The secondary lens 18₂ may be a lens or a reflector or a combination of both. In the case of a lens, it is conceivable that the lens utilises refraction and/or total reflection to deflect the radiation.

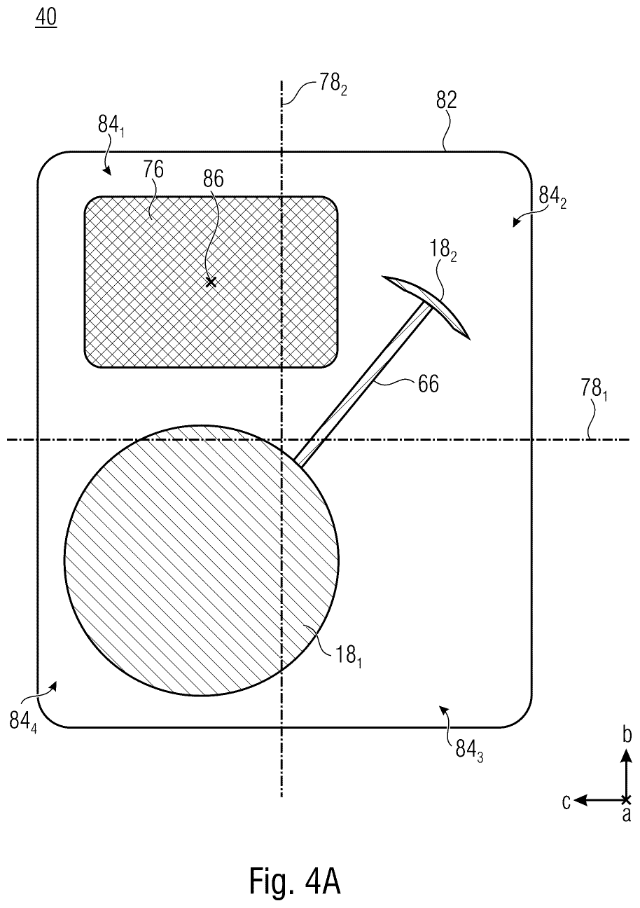

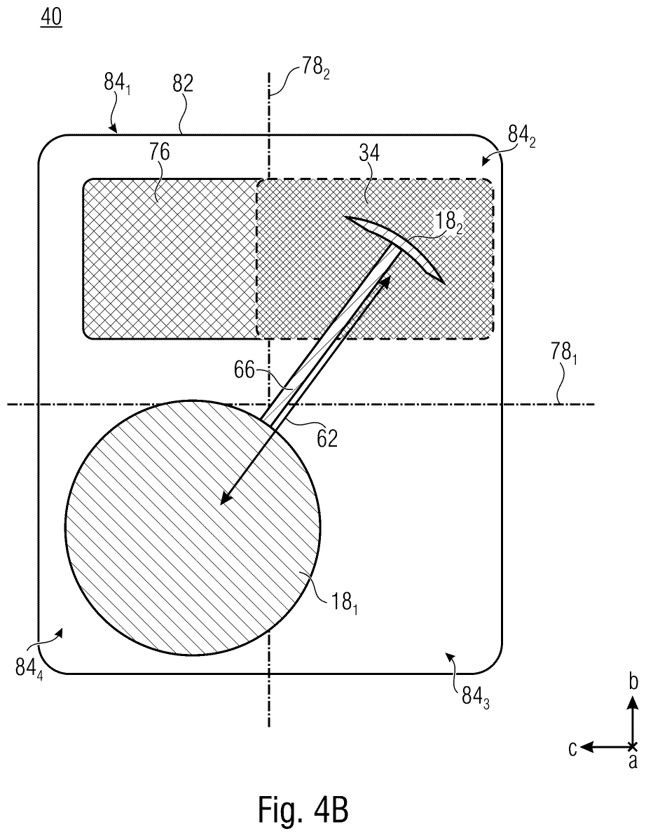

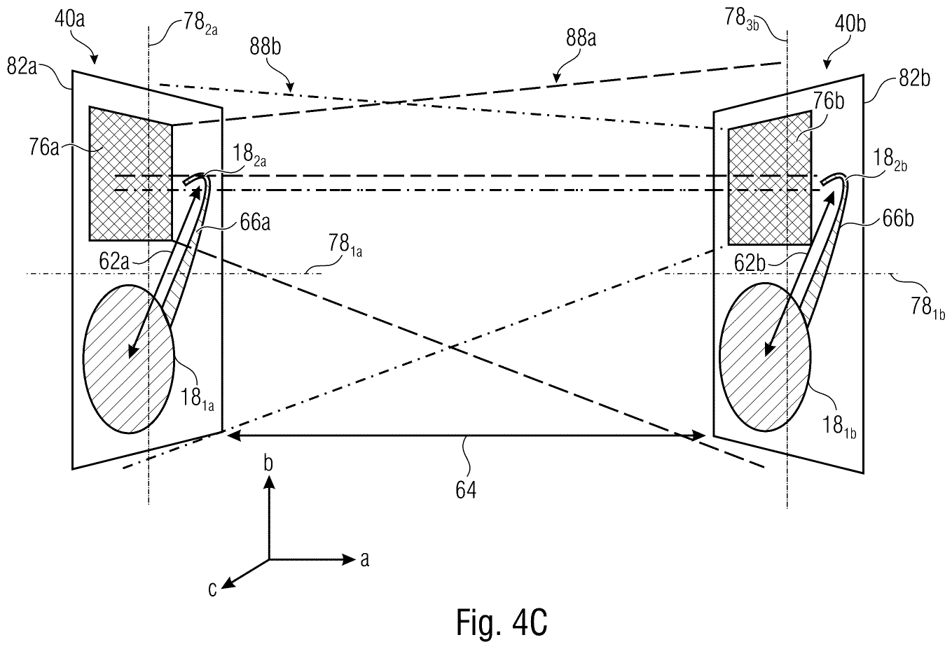

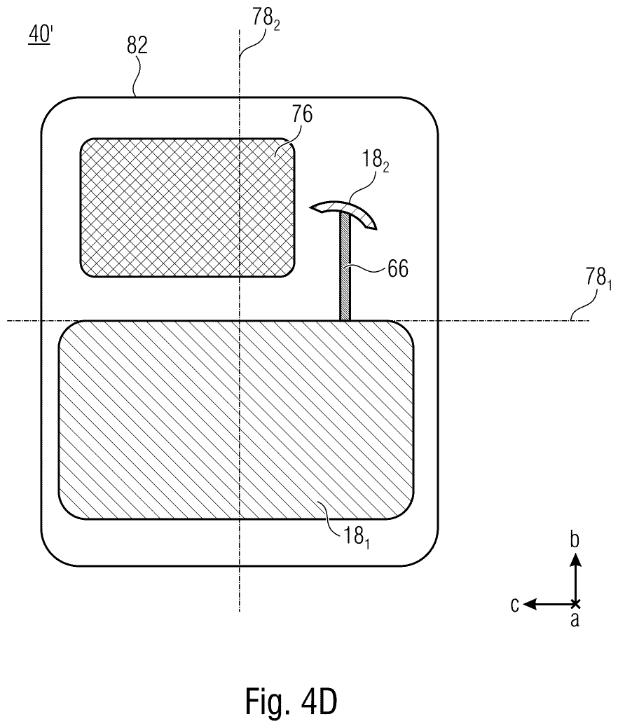

FIG. 4a shows a schematic top view of an optical wireless device 40 according to an embodiment. To make the illustration clearer, the optical detector 16 is not shown. However, the optical wireless device 40 may comprise a transmitting device 76, which may be formed in accordance with the transmitting device 34 and may enable bidirectional exchange of optical wireless signals. As an example, axes 781 and 78₂ are drawn in order to divide the side of a housing 82 shown into quadrants 84₁-84₄.

According to an embodiment, the optical wireless device 40 is configured in such a way that an structurally similar or identical further device 40 for bidirectional exchange can be configured precisely in order to utilise the advantages according to the invention on both sides of the communication link. In the case of a juxtaposition, i.e. an arrangement of the device 40 and its copy opposite one another, as indicated, for example, in FIGS. 3a and 3b, an arrangement may be obtained in such a way that in the arrangement of the transmitting device 76 and at least the primary optical system 18₁ and secondary optical system 18₂, which may optionally be connected by the connecting structure 66, the secondary optical system 18₂ has a smaller distance to a transmitting power centre 86, such as an origin of the primary transmission axis 42, than the primary optical system of the copy. If an exemplary copy is rotated by 180° about the axis 78₂ and shifted along the negative a-direction in space, the copied transmitting device 76 would overlap with the optical system 18₂ when projected into the c/b-plane; possibly the secondary optical system 18₂ would even overlap the copied power centre. The primary optical system 18₁, on the other hand, would be at a distance from the copied transmitting device and possibly only illuminated by the optical wireless signal if the distance between the device 40 and its copy is sufficiently large.

Although the primary optical system 18₁ is shown round, it may also have a different shape, for example an at least substantially rectangular cross-section, for example by additionally rounded edges as shown by way of example in FIG. 4d or the like.

In embodiments, a receiving device of an optical wireless device is configured to receive the received optical wireless signal of an emitting optical wireless transmitter both in a geometric near field and in a geometric far field and to detect it with the optical detector 16 without saturation. This aspect may also be implemented independently of the specific geometry of the optical systems described in connection with FIG. 1.

Each of the optical systems 18₁ and 18₂ may have a respective receiving field of view or this may be associated with the optical systems. Receiving fields of view of the plurality of optical systems may have different sizes, which can be expressed, for example, in different angles of incidence and/or the aperture size. The receiving fields of view of the plurality of optical systems overlap at most incompletely, so that a location of the optical transmitter at varying distances between the transmitter and the receiver may result in the transmitter not being seen by at least one receiving optical system at some distances and thus not transmitting light to the optical detector 16. At a different distance, the same receiving optical system can see the transmitter, i.e. it is illuminated by the transmitter, and can thus transmit the signal to the detector 16.

FIG. 4b shows a representation of the device 40 extended by the transmitting device 34 of the copy of device 40. Due to the rotation around the axis 78₂, the transmitting device 34, which is structurally identical to the transmitting device 76, is positioned opposite the secondary optical system 18₂, wherein the offset 62 is clearly visible.

In other words, FIG. 4a shows a front view of an embodiment of a bidirectional communication link. It is advantageous for a product if all devices are identical and the peripherals, such as cable connections or similar, are located on the same side.

The advantageous arrangement discussed according to embodiments, as shown in FIG. 4a, may arrange the transmitter 76 and the receiver, represented by the optical systems 18₁ and 18₂, on one side of the housing 82, so that the optical arrangement described above is achieved. The transmitting device 76 may be used by the device 40 to implement a return channel. If the device 40 is rotated by 180° about the b axis or 78₂, the transmitter and receiver are positioned opposite each other in such a way that the optical axis of the secondary lens is approximately or exactly on the optical axis of the transmitter or has a predefined offset. The secondary lens 18₂ can thus cover the geometric near field. The primary receiving lens 18₁, on the other hand, is located on the optical axis of the optical detector 16.

Further in other words, for better illustration, the illustration of FIG. 4b shows the same system, with the transmitter 34 of the opposite device drawn in to clarify the relative positions of the transmitter 34/76 and the receiver 18₁, 18₂. Alternatively or additionally, it is conceivable to design both receiving lenses as a single complex lens module, which can reduce the number of components to be manufactured and assembled. In this case, for example, the components, parts or lenses 18₁ and 18₂ could be connected via a connecting structure 66 possibly formed as a web. The connecting structure 66 does not have to fulfil an optical function.

FIG. 4c shows a schematic, perspective view of two devices 40a and 40b, which are reciprocal copies of each other and are used for the discussion of the statements on FIG. 4a and FIG. 4b. Due to the described embodiment, it is possible that the respective secondary optical systems 18₂a and 18₂b are arranged opposite each other with respect to the respective transmitting device 76b or 76a of the other device, for example along the a-direction. An illuminated area 88a or 88b of the respective transmitting device 76a or 76b is variable by the distance 64 due to the described emission angle and becomes larger with increasing distance 64 to the transmitter. As may be seen from FIG. 4c, a reduction in the distance 64 may result in the primary optical system 18₁a and 18₁b being illuminated in decreasing order and not being illuminated or at least only partially illuminated as the distance decreases further.

Deviating from the illustration of FIGS. 4a and 4b, it would also be conceivable that the primary receiving lens 18₁ is configured differently and, for example, covers a large part of the housing area or the entire lower area of the housing. For example, a predominant or even entire portion of quadrants 84₃ and 84₄ may be covered by the lens or even a portion of quadrants 84₁ and 84₂. For example, it could be a lens with a rectangular cross-section in order to optimally utilise the space, as shown in FIG. 4d. The shape of the optical system 18₁ shown there is understood to be rectangular, irrespective of the rounded corners, since a portion of at least 80%, 90% or 95% of the outer edges is shown straight and would form a quadrangle if extended accordingly. Generalised, the cross-section of the primary receiving lens 18₁ may be arbitrary. Advantageously, the secondary lens 18₂ is at least approximately level with the transmitter 76 along the b direction when the system is rotated about the axis 78₂.

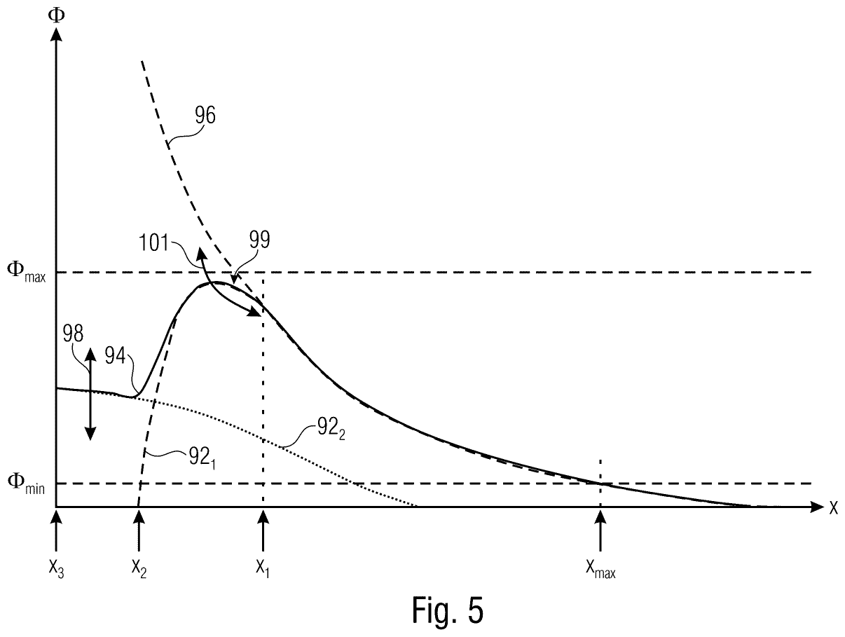

In other words, the system can work well if the system is rotated around the axis 78₂ and the transmitter covers a part of the upper left half and the secondary lens covers a part of the right half. The expansion of the components along the b-axis may play a lesser role for the basic function. However, the aim can be to design the distance between a respective transmitting device 76 and the primary optical system 18₁ along the b-axis to be as large as possible so that the maximum power 99 shown in FIG. 5 only occurs at the largest possible distance x and is therefore correspondingly small.

In principle, it is conceivable that the system are also rotated around a different axis and the transmitters and receivers are arranged accordingly in order to achieve a similarly effective arrangement in the geometric near field and geometric far field. The rotation of the device around the axis 78₂ is particularly advantageous, as possible cables and connectors can be routed downwards or upwards on both devices, for example in the positive b-direction or negative b-direction.

In a configuration that is particularly robust with respect to placement tolerances of the transmitter and the receiver, the transmitting lens of the transmitting device 76 may cover at least one quadrant of the housing 82, such as the quadrant 84₁. The secondary lens 18₂ may, for example, be located approximately in the centre of the neighbouring quadrant 84₂ in such a way that the secondary lens 18₂ is positioned exactly or at least approximately on the optical axis of the transmitter in the case of an opposite device. In this case, both devices can be shifted against each other as far as possible before the secondary optical system 18₂ of the opposite device is no longer directly in front of the transmitter 76.

FIG. 5 shows a schematic characteristic curve to illustrate the embodiments described herein. The graph shows an optical radiant power or radiant flux Φ on the ordinate, where the value Φₘᵢₙ can denote a lower detection threshold of an exemplary optical receiver or receiving device and Φₘₐₓ an upper threshold, above which the receiver operates poorly, for example goes into saturation. A distance x is plotted on the abscissa, which is approximately the distance 64 between the transmitter and receiver. At a maximum distance xₘₐₓ, the optical power received by a transmitter by means of an optical wireless signal 14 increases starting from greater distances until the minimum power Φₘᵢₙ is reached and the optical detector 16 is able to process the signal according to the specification. Specification is understood here as an intended operation, because a signal can also be physically receivable and possibly analysable below this threshold, but may be decoded with an unacceptable error rate, which is why the threshold Φₘᵢₙ can be system-dependent.

A characteristic curve 92₁ shows an exemplary course of an optical power, which is directed to the optical detector 16 by the primary optical system 18₁. A characteristic curve 92₂ shows an exemplary schematic course of an optical power that can be directed to the optical detector 16 by the secondary lens 18₂. Due to the smaller aperture, the secondary optical system 18₂ would only deliver sufficient optical power to the optical detector 16 at a much smaller distance. It may be seen that the secondary optical system provides a negligible portion in the geometric far field, and that the primary optical system provides a dominant portion of the total optical power at the optical detector 16 in the geometric far field. In the combined characteristic curve 94, which shows a sum of the characteristic curves 92₁ and 92₂, it may be seen that at a distance x₁ the power provided by the primary optical system 18₁ decreases and deviates from an expected course 96, the reason for this being that the primary optical system 18₁ is illuminated less and possibly no longer by the optical wireless transmitter as the distance x decreases further.

In the geometric near field, the optical power of the secondary optical system 18₂ becomes the dominant portion, as the primary optical system 18₁ is no longer illuminated when the distance x₂ is not reached. Here, the optical power can increase until a minimum distance x₃ is reached. By configuring the individual components accordingly, this may be done in such a way that the total power represented by the characteristic curve 94 is within the working interval below the power Φₘₐₓ. A power level 98 can therefore be corrected and adjusted. A maximum 99 may be configurated by configurating the corresponding components, which is shown by the arrow 101.

In other words, FIG. 5 shows the received power Φ plotted on the vertical axis over the distance between the transmitter and the receiver along the axis x. The horizontal line Φmax marks the maximum power at which the receiver still operates within the specification. The horizontal line Φₘᵢₙ marks the minimum power at which the receiver still operates within the specification. Only if the received power 94 lies between the two values, the function according to the example is provided.

In further other words, the characteristic curve 92₁ may exemplarily show the received power that the primary receiving lens 18₁ directs to the photodetector 16 of FIG. 1, wherein the implementations are readily applicable to other embodiments described herein. Coming from long distances, the received power may increase with decreasing communication distance, i.e. smaller x-values. If the transmitter and the primary receiving lens 18₁ had no offset 62₁, i.e. if their optical axes 42 and 58₁ were identical, the received power would continue to increase, as indicated by line 96. Due to the offset 62₁, the transmitter gradually moves out of the field of view of the primary receiver lens 18₁ at short distances, so that the received power does not continue to increase, but eventually reaches a maximum value and may eventually drop rapidly for even shorter distances. The received power that the secondary lens 18₂ directs onto the detector 16 is shown as a characteristic curve 92₂. The total power incident on the detector 16 may correspond to the sum of the primary optical system 18₁ and the at least one secondary optical system 18₂ and is shown for the structure of the devices 10 and 40 as a characteristic curve 94. A system that would only use the offset primary lens 18₂ would have a dynamic range from the distance x₂ to the distance xₘₐₓ. By using and combining the secondary optical system 18₂, the minimum distance improves to a significantly smaller value x₃, whereas the maximum range xₘₐₓ is not negatively affected. Although the secondary lens 18₂ may also direct power to the detector 16 at large distances, due to the smaller versions of the aperture, this portion of power can be significantly lower than the portion received by the primary optical system 18₁.

Embodiments provide for the characteristic curves 92₁ and 92₂ to be matched to each other in order not to exceed the maximum power Φₘₐₓ or not to fall below the minimum power Φₘᵢₙ within the operating range. One or more of the following design parameters are particularly suitable for specifically influencing the characteristic curves 92₁, 92₂ and/or 94. A particularly tolerant complete system with regard to system tolerances, but also alignment tolerances, may result if the characteristic curve 92₂ in particular has the maximum distance to the lower power limit and upper power limit Φₘᵢₙ or Φₘₐₓ, i.e. is arranged approximately in the centre of these. Parameters of the primary receiving optical systems 18₁, which can change the characteristic curve 92₁, in particular to adjust the maximum power level along the arrow 101, may be:
an offset of the optical axes 42 and 58₁, see for example FIG. 2, i.e. the offset 62 between the transmitter and the primary receiving lens 18₁;
   the greater the offset 62, the greater the distance at which the maximum of the detected power occurs, i.e. the maximum can be shifted along the arrow 101. The direction of the arrows 101 corresponds approximately to the course of the curve 96, wherein the actual maximum value lies below the curve 96. The maximum value, i.e. the maximum power, may decrease accordingly with increasing offset, as the primary receiving lens 18₁ can only detect radiation from the transmitter at greater distances. At a greater distance, the power density is lower.
an acceptance angle 52 of the primary receiving lens or adjustments to the optical concentration factor depending on the angle of incidence of the radiation;
dimensions of the primary receiving lens 18₁ and coupling angle 68₁, 68₂ to the detector element 16.

Alternatively or additionally, parameters for adjusting the secondary receiving optical system 18₂, which may change the characteristic curve 92₂, in particular for adjusting the power level 98, may include:
a position of the secondary optical system 18₂ in relation to the opposite transmitter, i.e. the offset 62₂ of FIG. 3a;
the position of the secondary receiving lens 18₂ in relation to the detector 16, i.e. also the coupling angle 68₂ to the detector;
an aperture size of the secondary optical system 18₂, an acceptance angle of the secondary receiving optical system 18₂, as well as its angle of incidence-dependent efficiency of radiation deflection to the detector 16

Alternatively or additionally, parameters of the emission profile of the transmitter may be changed, for example to change the characteristic curves 92₁ or 94.
The transmitter may distribute the optical power in such a way that it is homogeneously distributed over the output aperture or each virtual source has a similar power. The opposite is also possible; for example, a greater power density could occur in the centre of the output aperture of the transmitter than at the edge. The power signal of the secondary optical system 18₂ can be influenced by varying the local power density. Such a distribution may also affect the power directed to the detector 16 by the primary receiving lens 18₁. This occurs exactly in a case in which the transmitter is at the edge of the receiving field of view of the primary receiving lens and the primary receiving lens only sees a part of the transmitter aperture.
The channel loss and thus the reception level of the characteristic curves 92₂, 94 may depend on the emission angle and the acceptance angles of the primary receiving optical system 18₁ and the secondary optical system 18₂. Accordingly, both characteristic curves can be influenced by changing the emission angle above the output aperture of the transmitter. For example, each virtual source located directly opposite the secondary optical system 18₂ could have a smaller emission angle than the remaining virtual sources so that the secondary optical system 18₂ can direct as much power as possible from the transmitter to the detector 16. The reverse case, i.e. larger emission angles to reduce the detected power, is also conceivable.

With reference to FIG. 4d, an optical wireless communication system according to an embodiment may be configured for a minimum distance x₃ between the optical wireless transmitter and the optical wireless receiver arranged movably relative to each other or between two transceivers. The minimum distance can, for example, result from a working area or be influenced by the area within which communication is to take place. A minimum tolerance of the optical wireless communication system with respect to positioning inaccuracies with regard to an offset of the components relative to one another along the c direction and/or a direction and/or with regard to a tilting of the primary optical axes relative to one another may be determined by a size or aperture of the transmitting optical system. This may be represented in such a way that, at the minimum distance, the secondary optical system of the optical wireless receiver is at least partially opposite the transmitting optical system of the optical wireless transmitter in such a way that the emitted optical power is still sufficiently directed to the optical detector by the secondary optical system.

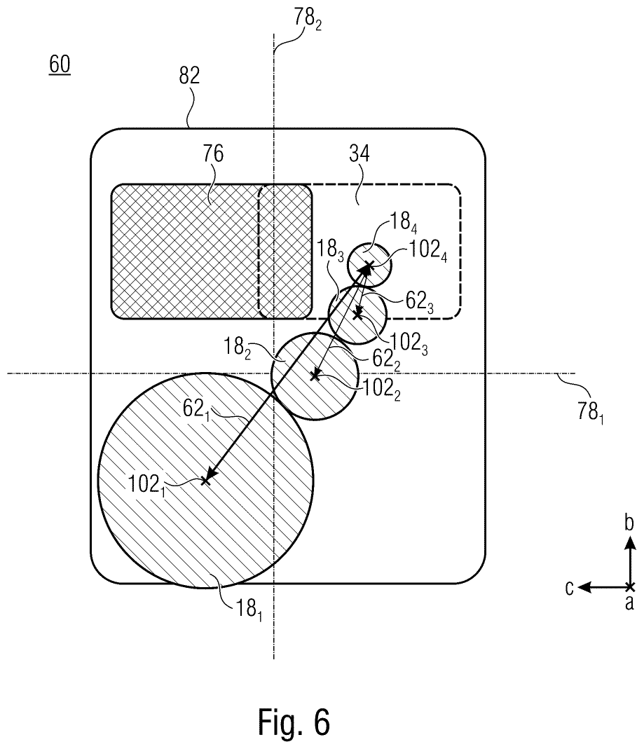

FIG. 6 shows a schematic front view of an optical wireless device 60 according to an embodiment. This may be configured similarly to the device 40, but in contrast may comprise a plurality of secondary optical systems 18₂, 18₃ and 18₄. The secondary optical systems 18₂-18₄ may be arranged in any number of, for example, 1, as shown in FIG. 4a and FIG. 4b, 2, 3, 4 or more. Preferably the plurality of secondary optical systems 18₂-18₄ are arranged in relation to the primary optical system 18₁ in such a way, that by an increasing distance from an optical centre 1021 of the primary optical system 18₁, the secondary optical systems 18₂-18₄ have a decreasing aperture size. This is illustrated in FIG. 6 by different sizes and, in particular, decreasing sizes of the optical systems 18₂-18₄ along the offset 62, wherein other means for reducing an aperture size may also be used, such as a lens shape other than a round lens shape.

The plurality of optical systems 18₁-18₄ may potentially be manufactured as a common body, which may have different optical active areas in the region of the optical systems 18₁-18₄. Alternatively or additionally, the optical systems may also be spaced apart and connected to one another, for example via a connecting structure 66, in order to achieve high positioning precision.

The secondary optical systems 18₂, 18₃, 18₄ may be arranged along a straight line, but may also be arranged with respect to their optical centres 102₂, 102₃ and 102₄ along a line, which is straight only in sections, or along a curve or the like, as shown in FIG. 6.

In other words, generalised with respect to the further embodiments, an implementation may be provided in which not only one secondary lens 18₂ is arranged, but a number of N>2 secondary lenses 18₂, 18₃, 18₄, . . . , wherein each of these secondary lenses or secondary optical systems may be optimised for a specific range of distances. This embodiment offers the advantage that the maximum reception level can be further reduced, i.e. the dynamic range can be further improved or the reception power can be further smoothed over the distance. FIG. 6 shows a frontal view of how exemplary secondary lenses or secondary optical systems 18₂, 18₃, 18₄ can be arranged. There are different arrangements, wherein an attempt can be made to reduce the offset 62₁ or the individual offset of a secondary optical system to the optical axis of the transmitter 34 with each additional secondary lens. The secondary optical system may be configured in such a way that the following applies: The greater the offset 62₁-62₄ to the optical axis of the transmitter 34, the less power the lens focusses in the geometric near field and the more in the geometric far field. The further explanations in connection with FIGS. 4a and 4b apply analogously here. For the sake of better visualisation, the transmitter 34 is only shown as a border without shading, but may have the same functionality as described in connection with FIG. 4b.

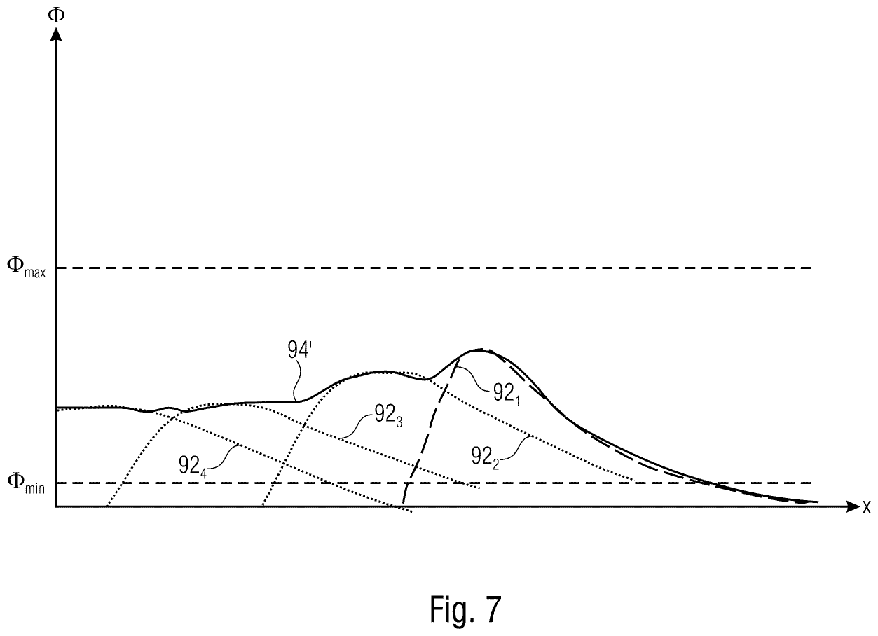

FIG. 7 shows a schematic diagram of an exemplary total intensity Φ, as can be obtained, for example, with an optical arrangement of the optical wireless device 60. In contrast to the representation of FIG. 5, an total characteristic curve 94′ can be formed from four characteristic curves 92₁, 92₂, 92₃, 92₄, analogous to the number of primary optical system and secondary optical systems of the device 60. By designing the transmitter 34 accordingly and aligning it accordingly, the characteristic curve 94′ can be more uniform compared to the characteristic curve 94 in FIG. 5, which is advantageous.

In other words, FIG. 7 shows an exemplary graph of the received power for the device 60 together with the transmitter 34 associated with FIG. 6, which together may form an exemplary system. Each of the secondary receiving lenses 18₂, 18₃, 18₄ can generate a received power to the detector 16 of the receiving device, as can the primary optical system 18₁. These are represented in total by the corresponding characteristic curves 92₁, 92₂, 92₃ and 92₄. The sum of the power incident on the detector 16 is shown as an example by the characteristic curve 94′. By using a number of secondary lenses, it is clear that the fluctuations in the reception level can be significantly reduced.

In an optical wireless communication system described herein, the plurality of optical systems of the receiving device of a first optical wireless device on the one hand and the transmitting power of the transmitting optical wireless device on the other hand may be matched to each other. At any distance between the first optical wireless device and the second optical wireless device, the optical detector 16 may remain without saturation, as illustrated in both FIG. 5 and FIG. 7.

According to an embodiment, the plurality of optical systems may comprise a first optical system as the primary optical system, such as the optical system 18₁, and a plurality of secondary optical systems, as described in connection with FIG. 6. Each of the plurality of secondary optical systems may be configured distance range to the second optical wireless device specific for an optical systems, which at most incompletely overlaps with a distance range of another secondary optical system. This may mean, for example, that a relevant area or an area with maximum optical power is shifted in relation to each other, as shown for example in FIG. 7. The adjustment may be made by selecting the offset along the b and/or c direction in the coordinate system of FIG. 6, and may alternatively or additionally also include a lens type and/or an aperture size. For this purpose, an optical axis of the transmitter 34 may be taken into account as well as a transmitting power of the transmitter 34.

According to an embodiment, in an optical wireless communication system, an emission angle of a transmitting device of the transmitting optical wireless device may be larger than a total field of view angle or total acceptance angle of the plurality of optical systems of the receiving optical wireless device. This can allow a certain tolerance for tilting when positioning the transmitter and the receiver.

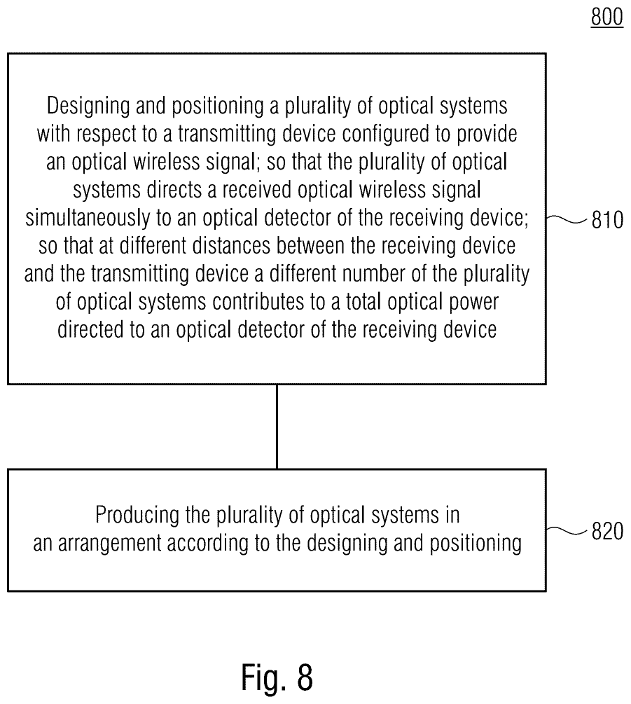

FIG. 8 shows a schematic flow chart of a method 800 according to an embodiment. A step 810 includes designing and positioning a plurality of optical systems with respect to a transmitting device configured to provide an optical wireless signal. This may be done such that the plurality of optical systems simultaneously directs a received optical wireless signal to an optical detector 16 of the receiving device, so that at different distances between the receiving device and the transmitting device a different number of the plurality of optical systems contributes to a total optical power directed to an optical detector 16 of the receiving device.

A step 820 includes producing the plurality of optical systems in an arrangement according to the designing and positioning.

According to an embodiment, the designing and positioning 810 includes taking into account at least one element of the group comprising an aperture angle of the transmitting device, a transmitting power of the transmitting device, a power distribution over the output aperture of the transmitting device; a relative distance of the plurality of optical systems to each other and to the optical axis of the transmitting device, an acceptance angle of the plurality of optical systems of the geometrical shapes of the apertures of the plurality of optical systems and/or a saturation limit of an optical detector 16 of the receiving device.

It is particularly advantageous if the parameters of the transmitting device and the receiving device are known and are taken into account in step 810. However, an advantageous design of the receiving optical system can also be made with only rough information regarding the transmitter or regarding an estimated property of the transmitter, for example by assuming an average transmitting power and/or an average or expected extension of the transmitter or the like. This may still enable a relevant improvement compared to known concepts.

Embodiments may be used, for example, as a data light barrier. In this case, data can be transmitted along a linear axis, wherein both transceivers may be individually stationary or mobile. Such arrangements may be found, for example, in hall, bridge and harbour cranes, in mobile trolleys, in mobile trolleys for transporting containers, pallets, lattice boxes or in automated parking systems for horizontal or vertical parking. Harbour cranes, for example, need a high dynamic range because they can be moved to within a few centimetres of a transmitter, but may also be several hundred metres away.

Embodiments provide components for an optical wireless transmitting and receiving system or such a system with one or more of the following features:
a transmitter for transmitting an optical wireless signal;
a receiver for receiving an optical wireless signal;
the receiver comprising a detector;
the receiver comprising a lens module or an optical module including a primary receiving lens, the optical axis of which is offset from the optical axis of the transmitter;
the receiver including at least one secondary receiving lens, wherein the optical axis of which has a smaller offset to the optical axis of the transmitter compared to the primary receiving lens or no offset to the optical axis of the transmitter at all.

A feature of further aspects relates to the fact that the field of view angle of the transmitter is larger than that of the receiver and the field of view angle of the primary receiving lens may also be designed differently to the field of view angle of the secondary receiving lens.

The embodiments described herein relate to an optical concept of transmitter and receiver which, compared to known concepts, possibly does not require additional components in order to achieve an improvement in dynamic range, but is based on a defined geometric transmitter and receiver arrangement. Additional components can be avoided, especially when the primary and secondary optical system are designed as integral or monolithic components. Even if the optical systems are manufactured as separate components, these additional components can be used simply and cheaply. To implement the invention, it may be sufficient to implement a single receiver so that the complexity of the electronics is not unnecessarily increased. The problem can already be solved by the design of the transmitter and receiver optical systems, which are needed in the system anyway. In this respect, the secondary receiver optical systems can be regarded as a design within an existing component. The concept also needs only a marginal change in the design of the transmitting and receiving optical systems in terms of optical efficiency/performance in the optical channel compared to known solutions. Thus, in embodiments, no or only low radiation can be utilised at comparatively large angles, which would no longer be usable over large distances. The present invention allows a comparatively large tolerance with respect to a lateral offset of the devices relative to each other perpendicular to the optical axis, which may occur in practice due to tolerances. Advantages of embodiments described herein include, but are not limited to:
high to very high efficiency, as no power loss has to be accepted in order to cover the geometric near field;
a very high achievable dynamic range;
robustness against mechanical misalignment of the transmitter and the receiver;
low channel crosstalk;
no need for an active control loop, which also eliminates the need for frequency dependency;
only an existing detector is needed;
only a transmitting lens is needed;
a complex lens module on the receiver is sufficient; a receiving lens is already present, which is divided into two or more lenses/optical systems in embodiments;
compatibility with other approaches that introduce additional control, such as an adaptive transmitter power.

Although some aspects have been described in connection with a device, it is understood that these aspects also constitute a description of the corresponding method, so that a block or component of a device is also to be understood as a corresponding method step or as a feature of a method step. Similarly, aspects described in connection with or as a method step also constitute a description of a corresponding block or detail or feature of a corresponding device.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LITERATURE

[1] ROJAS CALVENTE FRANCISCO; SUMASTA PAMUNGKAS: METHOD AND APPARATUS FOR AVOIDING SATURATION IN OPTICAL WIRELESS POINT-TO-POINT SYSTEMS, WO22200124 A1, SIGNIFY HOLDING BV.
[2] S. Huang and M. Safari, “Reliable Optical Empfänger for Highly Dynamic Wireless Channels: An Experimental Demonstration,” 2021 IEEE Global Communications Conference (GLOBECOM), 2021, pp. 1-6, doi: 10.1109/GLOBECOM46510.2021.9685634.
[3] Bassam Hanal, Thalwtl (CH). Hartmut Rudmann. Jona (CH), Mario Cessna, Au (CH); Nicole Ebentheuer, Zurich (CH): TRANSCEIVER MODULE INCLUDING OPTICAL SENSOR AT A ROTATIONALLY SYMMETRIC POSITION, US Patent, U.S. Pat. No. 10,547,385 B2, ams Sensors Singapore Pte. Ltd., Singapore (SCJ)
[4] Fritz Gfeller, DRAHTLOSES OPTISCHES ÜBERTRAGUNGSSYSTEM MIT ADAPTIVER DATENÜBERTRAGUNGSGESCHWINDIGKEIT, DE 694 11 954.7, International Business Machines Corporation, Armonk, N.Y., US, int. Publication date: 26.10.1995
[5] Yakov G. Soskind, Thirukumar Vethanayagam “Optical Empfänger With High Dynamic Range”, U.S. Pat. No. 6,954,580B2, JDS Unipahse Corporation, 11.10.2005.
[6] Eken, Yalcin Alper, Oguz, Alp, ANALOGER FRONT-END-EMPFÄNGER MIT GROSSEM DYNAMIKBEREICH FÜR LONG-RANGE-LIDAR, DE 10 2018 106 762 A1 Analog Devices Global Unlimited Company, publication: 2018.09.27.
[7] Kirrbach, Rene; Schneider, T., “Augensichere optisch-drahtlose Kommunikation”, WO 2021/228697 A1, Publication date: 18.11.2021

1. An optical wireless device with a receiving device which is configured to receive an optical wireless signal;
wherein the receiving device comprises an optical detector for detecting the optical wireless signal and a plurality of optical systems with at least a first optical system with a first aperture size and a second optical system with a second smaller aperture size arranged side by side with substantially the same advantageous direction;
wherein each of the plurality of optical systems is configured to simultaneously direct a light incident on the optical system to the optical detector;
wherein the optical detector comprises an optical axis and the first optical system is arranged at a first distance from the optical axis and the second optical system is arranged at a greater second distance from the optical axis.

2. The optical wireless device according to claim 1, wherein the first optical system is arranged centrally above the optical detector; and the second optical system is arranged at a distance from the optical axis of the optical detector.

3. The optical wireless device according to claim 1, wherein the first optical system is configured to direct incident light along an advantageous direction of the first optical system towards the optical detector;
wherein the second optical system is configured to direct incident light along a direction different from an advantageous direction of the first optical system towards the optical detector.

4. The optical wireless device according to claim 3, wherein the first optical system and the second optical system differ with respect to a size of a receiving field of view associated with the respective optical system, and the first optical system is the optical system with the largest receiving field of view of the plurality of optical systems.

5. The optical wireless device according to claim 3, wherein the second optical system is configured for a refraction and at least a first total reflection to direct the incident light along the direction different from the advantageous direction of the first optical system towards the optical detector.

6. The optical wireless device according to claim 1, wherein the first optical system is a primary optical system of the plurality of optical systems and comprises a smallest angle of incidence within the plurality of optical systems on the optical detector; wherein the second optical system is a secondary optical system of the plurality of optical systems.

7. The optical wireless device according to claim 6, wherein the primary optical system comprises a rectangular cross-section.

8. The optical wireless device according to claim 6 with a plurality of secondary optical systems which are arranged in relation to the primary optical system in such a way that the secondary optical systems comprise a decreasing aperture size with increasing distance from an optical centre of the primary optical system.

9. The optical wireless device according to claim 1 with a transmitting device for transmitting optical wireless signals; wherein the transmitting device comprises an emitter array, a device for magnification of the apparent source or a device for generating one of multiple apparent sources of an optical emitter.

10. The optical wireless device according to claim 9, wherein the transmitting device is configured as a device for magnification of the apparent source or for generating multiple apparent sources and comprises:
an optical transmitter for generating an optical signal; and
a separation optical system, configured to spatially divide the optical signal into a plurality of partial optical signals to divide an optical power of the optical signal into the plurality of partial optical signals with an associated spectral range, wherein the plurality of spectral ranges at least partially coincide.

11. The optical wireless device according to claim 1, wherein each optical system of the plurality of optical systems is associated with a respective receiving field of view and receiving fields of view of the plurality of optical systems comprise a different size from each other.

12. The optical wireless device according to claim 1, wherein the plurality of optical systems are monolithically fixed with respect to their relative position to each other via a connecting structure.

13. An optical wireless device with a receiving device which comprises an optical detector and which is configured to receive an optical wireless signal from an optical wireless transmitter; wherein the receiving device is configured to receive the optical wireless signal both in a geometric near field and in a geometric far field of the optical wireless transmitter and to detect it with the receiving device without saturation, in that the optical wireless device is configured to receive the optical signal of the transmitter in the geometric near field of the transmitter with the optical detector merely by a subset of the plurality of optical systems, and in the geometric far field, other or a higher number of the plurality of optical systems receive the signal.

14. The optical wireless device according to claim 13, wherein the receiving device comprises a first optical system and a second optical system of a plurality of optical systems, which are arranged side by side and substantially with the same advantageous direction;
wherein each of the plurality of optical systems is configured to simultaneously direct a light incident on the optical system to the optical detector;
wherein the optical detector comprises an optical axis and the first optical system is arranged at a first distance from the optical axis and the second optical system is arranged at a greater second distance from the optical axis.

15. An optical wireless communication system with:
a first optical wireless device according to claim 1; and
a second optical wireless device which is configured to transmit the optical wireless signal;
wherein at different distances between the first optical wireless device and the second optical wireless device, a different number of optical systems of the receiving device of the first optical wireless device is illuminated with the transmitted optical wireless signal and contribute to a total optical power directed to the detector.

16. The optical wireless communication system according to claim 15, wherein the first optical system as a primary optical system of the plurality of optical systems in a geometric far field of an optical transmitting device of the second optical wireless device provides a dominant portion to the total optical power at the optical detector of the first optical wireless device; and the second optical system as a secondary optical system of the plurality of optical systems in a geometric near field of the transmitting device of the second optical wireless device provides a dominant portion to the total optical power at the optical detector.

17. The optical wireless communication system according to claim 15, wherein an acceptance angle of the plurality of optical systems of the first optical wireless device is smaller than an emission angle of a transmitting device of the second optical wireless device configured to transmit the optical wireless signal.

18. The optical wireless communication system according to claim 15, wherein the plurality of optical systems of the receiving device of the first optical wireless device on the one hand and a transmitting power of the second optical wireless device on the other hand are matched to each other, and at any distance between the first optical wireless device and the second optical wireless device the receiving device remains without saturation.

19. The optical wireless communication system according to claim 15, which is configured for a minimum distance between the first optical wireless device and the second optical wireless device, wherein a minimum tolerance of the optical wireless communication system to positioning inaccuracies is determined by an aperture size of the transmitting optical system, such that at the minimum distance the secondary optical system of the first optical wireless device is arranged opposite the transmitter.

20. The optical wireless communication system according to claim 15, wherein the plurality of optical systems comprises the first optical system as a primary optical system and a plurality of secondary optical systems, wherein each of the plurality of secondary optical systems is configured for a distance range specific for the optical system to the second optical wireless device which at most incompletely overlaps with a distance range of another secondary optical system.
